(19) United States
(12) Patent Application Publication
(10) Pub. No.: US 2023/0419664 A1
(43) Pub. Date: Dec. 28, 2023

(54) CAUSE TRACKING SYSTEM, CAUSE TRACKING METHOD, AND STORAGE MEDIUM

(71) Applicant: TOYOTA JIDOSHA KABUSHIKI KAISHA, Toyota-shi (JP)

(72) Inventors: Yuto MORI, Toyota-shi (JP); Shintaro YOSHIZAWA, Nagoya-shi (JP); Kazuhiro SHINTANI, Toyokawa-shi (JP); Masayoshi TSUCHINAGA, Nisshin-shi (JP); Hisataka YUASA, Toyota-shi (JP); Takayuki KANAI, Toyota-shi (JP)

(73) Assignee: TOYOTA JIDOSHA KABUSHIKI KAISHA, Toyota-shi (JP)

(21) Appl. No.: 18/133,052

(22) Filed: Apr. 11, 2023

(30) Foreign Application Priority Data
Jun. 27, 2022 (JP) 2022-102764

(51) Int. Cl. G06V 20/40

(52) U.S. Cl. CPC G06V 20/44; G06V 20/48; G06V 20/46

(57) ABSTRACT

The cause tracking system according to the present disclosure includes: an event detecting unit that detects a new event occurring in a management target area; a recording unit that records an event detected in the past by the event detecting unit; a calculating unit that calculates a degree of association between the new event and a past event recorded in the recording unit; a recording control unit that causes the recording unit to record the new event as a past event in association with information on a past event in which the degree of association with the new event is equal to or greater than a threshold among past events recorded in the recording unit; and an output unit that reads out, from the recording unit, the designated event among the past events recorded in the recording unit and the other past events related to the designated event.

### CROSS-REFERENCE TO RELATED APPLICATION

This application claims priority to Japanese Patent Application No. 2022-102764 filed on Jun. 27, 2022, incorporated herein by reference in its entirety.

### BACKGROUND

### 1. Technical Field

The present disclosure relates to a cause tracking system, a cause tracking method, and a storage medium.

### 2. Description of Related Art

In recent years, when an event such as a failure of a machine or a work delay occurs, it is required to efficiently investigate and identify a cause of the event. A related technique is disclosed in, for example, Japanese Unexamined Patent Application Publication No. 2014-127093 (JP 2014-127093 A).

An event analysis device disclosed in JP 2014-127093 A includes an event log collection unit that collects an event log, an event log storage unit that converts the event log into an event matrix in which the presence or absence of occurrence of an event for each device event in which a device identifier and an event type identifier are combined is indicated in time series and that stores the event matrix, and an event analysis unit that calculates a conditional probability between the device events to construct a Bayesian network by dividing the event matrix into blocks each having a predetermined reference time width and determining the presence or absence of occurrence of each device event for each block, and outputs the device event that is considered to be a cause of the device event to be analyzed or that is considered to occur later using the constructed Bayesian network.

### SUMMARY

However, in the event analysis device disclosed in JP 2014-127093 A, it is necessary to collect large-scale data in advance and accumulate an event matrix. Further, in the event analysis device disclosed in JP 2014-127093 A, it is necessary to construct a Bayesian network using the accumulated event matrix.

Therefore, there is an issue that a cause of a device event to be analyzed cannot be identified at the initial stage of the start of an operation.

An object of the present disclosure is to provide a cause tracking system, a cause tracking method, and a cause tracking program capable of easily identifying a cause of occurrence of a designated event without performing large-scale data collection in advance.

A cause tracking system according to the present disclosure includes: an event detecting unit that detects a new event that has occurred in a management target area;

a recording unit in which events detected in the past by the event detecting unit are recorded;
a calculating unit that calculates a degree of association between the new event detected by the event detecting unit and past events recorded in the recording unit;
a recording control unit that links the new event with information on a past event in which the degree of association with the new event is equal to or higher than a threshold value among the past events recorded in the recording unit, and causes the recording unit to record the new event as the past event; and
an output unit that reads out a designated event among the past events recorded in the recording unit and other past events associated with the designated event from the recording unit, and outputting the designated event and the other past events.
In the cause tracking system, the detected new event is liked with the past event that is highly associated with the new event, and the new event is recorded in the recording unit as the past event. Therefore, when a cause of occurrence of the event designated as a cause tracking target is tracked, it is possible to preferentially present the event that is highly associated with the designated event. Thus, the cause tracking system can facilitate identification of the cause of occurrence of the designated event. Here, the cause tracking system can identify the cause of occurrence of the designated event from the initial stage of the start of the operation without performing large-scale data collection in advance. That is, the cause tracking system can easily identify the cause of occurrence of the designated event without performing large-scale data collection in advance.

The calculating unit according to the cause tracking system may be configured to calculate the degree of association between the new event detected by the event detecting unit and the past events recorded in the recording unit based on at least one of an occurrence location and an occurrence time of each of the new event and the past events.

The calculating unit according to the cause tracking system may be configured to calculate the degree of association between the new event detected by the event detecting unit and the past events recorded in the recording unit based on a person involved in occurrence of each of the new event and the past events.

The event detecting unit according to the cause tracking system may be configured to detect an event that has occurred at a predetermined location as the new event serving as a cause tracking target when a numerical value indicating a degree of normality of the event exceeds a range of an allowable value assigned to the predetermined location.

The recording control unit according to the cause tracking system may delete a past even in which the degree of association with the other past events is equal to or lower than a predetermined value among the past events recorded in the recording unit.

The event detecting unit according to the cause tracking system may be configured to detect the new event using a camera.

In the cause tracking system,

a calculation result by the calculating unit may be further accumulated in the recording unit, and
the cause tracking system may further include a presenting unit that presents an arrangement plan of a camera based on the calculation result by the calculating unit, the calculation result being accumulated in the recording unit.

The output unit according to the cause tracking system may preferentially output an event in which the degree of association with the designated event is high among the other past events associated with the designated event.

The output unit according to the cause tracking system may read out the designated event among the past events recorded in the recording unit and the other past events associated with the designated event from the recording unit, and display the designated event and the other past events on a monitor.

When the past events are not recorded in the recording unit, the recording control unit according to the cause tracking system may cause the recording unit to record the new event without linking the new event with information on the past events.

A cause tracking method according to the present disclosure includes:

detecting a new event that has occurred in a management target area;
calculating a degree of association between the new event and events detected in the past and recorded in a recording unit;
linking the new event with information on a past event in which the degree of association with the new event is equal to or higher than a threshold value among past events recorded in the recording unit, and causing the recording unit to record the new event as the past event; and
reading out a designated event among the past events recorded in the recording unit and other past events associated with the designated event from the recording unit, and outputting the designated event and the other past events.
In the cause tracking method, the detected new event is liked with the past event that is highly associated with the new event, and the new event is recorded in the recording unit as the past event. Therefore, when a cause of occurrence of the event designated as a cause tracking target is tracked, the cause tracking method can preferentially present the event that is highly associated with the designated event. Therefore, the cause tracking method can facilitate identification of the cause of occurrence of the designated event. Here, the cause tracking method can identify the cause of occurrence of the designated event from the initial stage of the start of the operation without performing large-scale data collection in advance. That is, the cause tracking method can easily identify the cause of occurrence of the designated event without performing large-scale data collection in advance.

A storage medium according to the present disclosure stores a cause tracking program that causes a computer to execute processes including

detecting a new event that has occurred in a management target area;
calculating a degree of association between the new event and events detected in the past and recorded in a recording unit;
linking the new event with information on a past event in which the degree of association with the new event is equal to or higher than a threshold value among past events recorded in the recording unit, and causing the recording unit to record the new event as the past event; and
reading out a designated event among the past events recorded in the recording unit and other past events associated with the designated event from the recording unit, and
outputting the designated event and the other past events.
In the cause tracking program, the detected new event is liked with the past event that is highly associated with the new event, and the new event is recorded in the recording unit as the past event. Therefore, when a cause of occurrence of the event designated as a cause tracking target is tracked, the cause tracking program can preferentially present the event that is highly associated with the designated event. Thus, the cause tracking program can facilitate identification of the cause of occurrence of the designated event. Here, the cause tracking program can identify the cause of occurrence of the designated event from the initial stage of the start of the operation without performing large-scale data collection in advance. That is, the cause tracking program can easily identify the cause of occurrence of the designated event without performing large-scale data collection in advance.

According to the present disclosure, it is possible to provide the cause tracking system, the cause tracking method, and the cause tracking program capable of easily identifying the cause of occurrence of the designated event without performing large-scale data collection in advance.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram illustrating a configuration example of a cause tracking system according to Embodiment 1;

FIG. 2 is a schematic perspective view showing a first application case of the cause tracking system shown in FIG. 1;

FIG. 3 is a flowchart illustrating an example of the operation of the cause tracking system illustrated in FIG. 1;

FIG. 4 is a diagram illustrating an example of information related to a plurality of past events recorded in a recording unit;

FIG. 5 is a diagram illustrating an example of display contents of a monitor;

FIG. 6 is a schematic diagram illustrating a second application of the cause tracking system shown in FIG. 1;

FIG. 7 is a diagram for explaining a flow of normal-time event generation in the second application case of the cause tracking system shown in FIG. 1; and

FIG. 8 is a diagram for explaining a flow of occurrence of an event at the time of abnormality in the second application case of the cause tracking system shown in FIG. 1.

### DETAILED DESCRIPTION OF EMBODIMENTS

Hereinafter, the present disclosure will be described through embodiments of the disclosure. However, the disclosure according to the claims is not limited to the following embodiments. Moreover, all of the configurations described in the embodiments are not necessarily indispensable as means for solving the issue. In order to clarify the explanation, the following description and drawings have been omitted or simplified as appropriate. In each drawing, the same elements are designated by the same reference signs, and duplicate explanations are omitted as necessary.

### First Embodiment

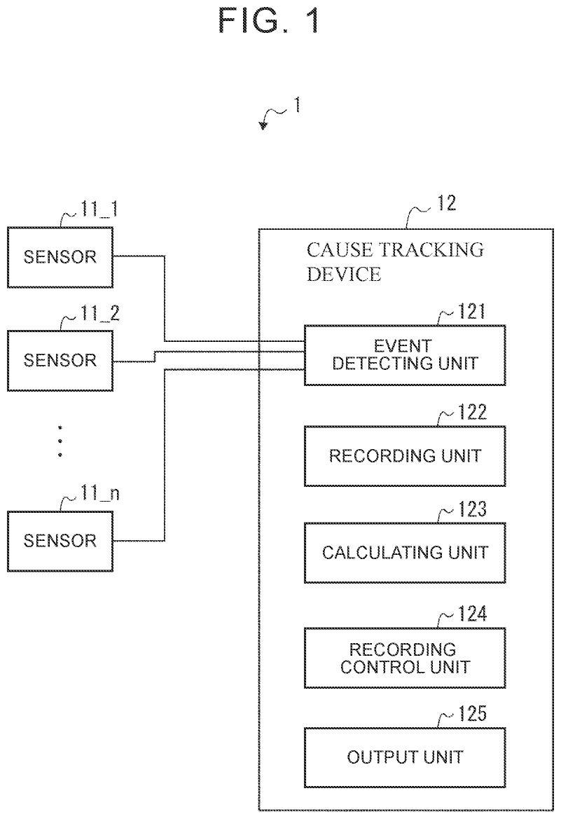

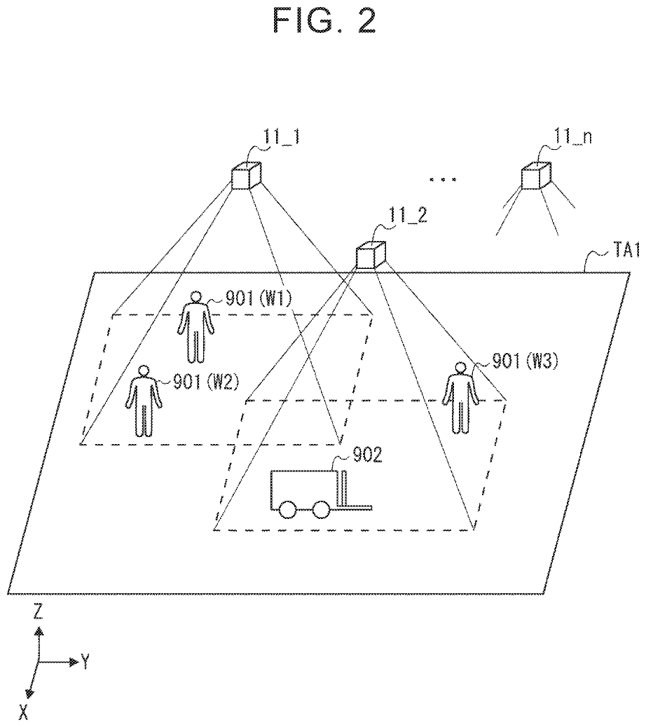

FIG. 1 is a block diagram illustrating a configuration example of a cause tracking system 1 according to a first embodiment. FIG. 2 is a schematic perspective view showing a first application example of the cause tracking system 1. The cause tracking system 1 according to the present embodiment records the detected new event in the recording unit as a past event in association with a past event that is highly related to the new event. Therefore, the cause tracking system can preferentially present an event that is highly related to the designated event when tracking the cause of occurrence of the event designated as the cause tracking target. Thus, the cause tracking system can facilitate identification of the cause of occurrence of the designated event. Here, the cause tracking system 1 according to the present embodiment can identify the cause of occurrence of a designated event from the initial stage of operation without performing large-scale data collection in advance. That is, the cause tracking system 1 according to the present embodiment can easily identify the cause of occurrence of a designated event without performing large-scale data collection in advance. Hereinafter, it will be described in detail.

The cause tracking system 1 is applied to a facility such as a factory, and includes n sensors 11_1 to 11_n (n is an integer of 1 or more) and a cause tracking device 12. The cause tracking device 12 may also be referred to as a cause tracking system.

The sensors 11_1 to 11_n are installed on the ceiling or the like of the facility, and detect objects such as the worker 901, the moving body 902, and the processing machine, which are present in the management target area TA1 in the facility.

The moving body 902 is, for example, a vehicle such as a forklift truck or a moving cart for transporting a product or a component thereof, an Automatic Guided Vehicle (AGV) set to automatically travel along a predetermined moving path, or an Autonomous Mobile Robot (AMR) set to automatically perform a predetermined operation. In FIG. 2, three worker W1 to W3 exist as the worker 901 and one forklift exists as the moving body 902 in the management target area TA1, but the present disclosure is not limited thereto, and one or more workers 901 and one or more moving bodies 902 may exist. A part of the sensors 11_1 to 11_n may be attached to at least one of the worker 901 and the moving body 902.

The sensors 11_1 to 11_n are, for example, cameras, and are installed so as to be able to capture the entire management target area TA1 in the facility. Note that the sensors 11_1 to 11_n are not limited to the case of a camera, and may be any type of sensor capable of detecting the worker 901, the moving body 902, and the like, such as a distance measuring sensor.

The cause tracking device 12 is a device that enables efficient tracking of the cause of occurrence of the designated event by preferentially presenting past events that are highly related to the designated event when tracking the cause of occurrence of the event designated as the cause tracking target by the user of the system or the like. The event is a predetermined operation performed by any one of the worker 901, the moving body 902, and an object such as a processing machine, or an abnormality caused by any one of the worker 901, the moving body 902, and an object such as a processing machine. For example, events may include a worker walking out, a worker stopping, a worker dropping a tool, a machine stopping, and a worker delaying work.

Specifically, the cause tracking device 12 includes at least an event detecting unit 121, a recording unit 122, a calculating unit 123, a recording control unit 124, and an output unit 125.

The event detecting unit 121 detects a new event NE generated in the management target area TA1. Specifically, the event detecting unit 121 specifies a predetermined operation of the worker 901 or a new event NE such as stopping of a machine (not shown), which has occurred in the management target area TA1, from the detection results (for example, captured images of cameras) by the sensors 11_1 to 11_n.

The recording unit 122 records a plurality of event OE previously detected by the event detecting unit 121.

The calculating unit 123 calculates the degree of association between the new event NE detected by the event detecting unit 121 and each of the plurality of historical event OE recorded in the recording unit 122.

For example, the calculating unit 123 may be configured to calculate the degree of association between the new event NE detected by the event detecting unit 121 and each of the plurality of past event OE recorded in the recording unit 122 based on at least one of the location of occurrence and the time of occurrence of each of the new event NE and the past event OE. In this case, for example, the past event OE whose occurrence time is closer to the occurrence time of the new event NE among the plurality of past event OE is determined to have a higher degree of association with the new event NE. In addition, among the plurality of past event OE, it is determined that the association degree with the new event NE is lower as the occurrence time of the past event OE is farther from the occurrence time of the new event NE. Further, among the plurality of past event OE, the past event OE in which the occurrence location is closer to the occurrence location of the new event NE is determined to have a higher degree of association with the new event NE, and the past event OE in which the occurrence location is farther from the occurrence location of the new event NE is determined to have a lower degree of association with the new event NE.

Further, the calculating unit 123 may be configured to calculate the degree of association between the new event NE detected by the event detecting unit 121 and each of the plurality of past event OE recorded in the recording unit 122 based on the new event NE and the person involved in the generation of each of the past event OE. In this case, for example, the past event OE in which the same person or a person close to the person involved in the occurrence of the new event NE among the plurality of past event OE is involved in the occurrence is determined to have a higher degree of association with the new event NE. It is determined that the association degree with the new event NE is low in the previous event OE in which the person involved in the generation of the new event NE and the person having a low working relationship are involved.

The recording control unit 124 causes the recording unit 122 to record the new event NE as past event OE in association with past event OE in which the degree of association with the new event NE is equal to or greater than a threshold among the plurality of past event OE recorded in the recording unit 122. The threshold value can be arbitrarily set by a user or the like. When the past event has not yet been recorded in the recording unit 122, the recording control unit 124 naturally causes the recording unit 122 to record the new event NE without being associated with the past event OE.

The output unit 125 reads out, from the recording unit 122, the event OE designated as the cause-tracking target and the other past event OE related to the designated event among the plurality of past event OE recorded in the recording unit 122, and outputs them. For example, the output unit 125 displays the event OE designated as the cause-tracking target and the other past event OE related to the designated event among the plurality of past event OE recorded in the recording unit 122 on the monitor in a desired display format. The monitor may be provided in the cause tracking device 12 or may be provided in an operation terminal (not shown).
Operation of the Cause Tracking System 1

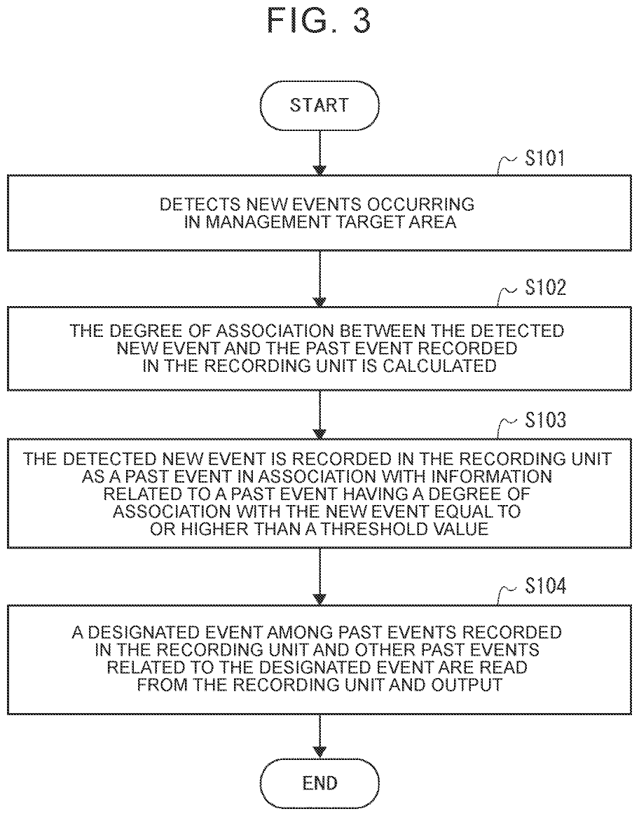

Next, the operation of the cause tracking system 1 will be described with reference to FIG. 3 in addition to FIGS. 1 and 2. FIG. 3 is a flowchart showing the operation of the cause tracking system 1. It should be noted that, in the following description, the cause tracking system 1 is applied to the facility shown in FIG. 2.

In the cause tracking system 1, the cause tracking device 12 first detects a new event NE occurring in the management target area TA1 (step S101). Specifically, the cause tracking device 12 identifies the new event NE generated in the management target area TA1 from the detection results (e.g., captured images of cameras) by the sensors 11_1 to 11_n.

For example, the cause tracking device 12 detects that the walking worker W1 of the worker W1 to W3 has stopped as a new event NE.

Thereafter, the cause tracking device 12 calculates the degree of association between the detected new event NE and each of the plurality of previous event OE recorded in the recording unit 122 (step S102).

Thereafter, the cause tracking device 12 causes the recording unit 122 to record the new event NE as the past event OE in association with the past event OE in which the degree of association with the new event NE is equal to or greater than the threshold among the plurality of past event OE recorded in the recording unit 122 (step S103).

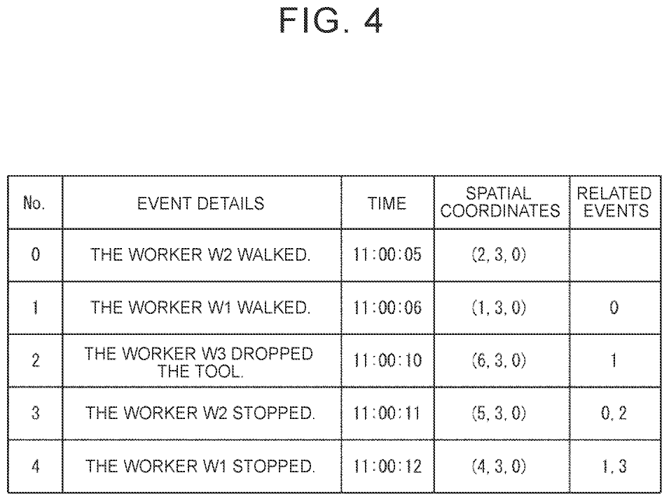

FIG. 4 is a diagram illustrating an exemplary OE of a plurality of historical events recorded in the recording unit 122. Referring to FIG. 4, in the recording unit 122, first, an event number “0” (hereinafter referred to as “No. 0”) and an event content “worker W2 walked out.”, information indicating that the event occurrence time is 11:00:05, the space coordinate is “(2, 3, 0)”, and the related event number is “none” is recorded. Further, in the recording unit 122, an event number “1” (hereinafter referred to as “No. 1”) and an event content “worker W1 walked out.”, information indicating that the event occurrence time is 11:00:06, the space coordinate is “(1, 3, 0)”, and the related event number is “0” is further recorded. In addition, in the recording unit 122, the event number “2” (hereinafter referred to as “No. 2”) and the event content “operator W3 dropped the tool.”, information indicating that the event occurrence time is 11:00:10, the space coordinate is “(6, 3, 0)”, and the related event number is “1” is further recorded. In addition, in the recording unit 122, the event number “3” (hereinafter referred to as “No. 3”) and the event content “worker W2 stopped.”, information indicating that the event occurrence time is 11:00:11, the space coordinate is “(5, 3, 0)”, and the related event number is “0, 2” is further recorded. In addition, in the recording unit 122, the event number “4” (hereinafter referred to as “No. 4”) and the event content “worker W1 stopped.”, information indicating that the event occurrence time is 11:00:12, the space coordinate is “(4, 3, 0)”, and the related event number is “1, 3” is further recorded.

Note that the related event associated with each event is determined based on a difference in occurrence time between events, a difference in occurrence position between events, a person involved in occurrence of an event, and the like. In the embodiment of FIG. 4, the cause tracking device 12 causes the recording unit 122 to record the new event NE in association with the past event OE of each of No. 1 and No. 3 determined to be highly related to the new event NE as the past event OE of No. 4. Note that the event of No. 4 and the event of No. 1 are determined to be highly related because the workers are the same. Moreover, since the event of No. 4 and the event of No. 3 are close to each other, it is determined that the event is highly related to each other.

Thereafter, the cause tracking device 12 reads out the event OE designated as the cause tracking target and other past event OE related to the designated event from the plurality of past event OE recorded in the recording unit 122 from the recording unit 122 and outputs them (step S104). For example, when the cause tracking device 12 tracks the cause of the event of “the worker W1 of No. 4 is stopped” among the plurality of past event OE recorded in the recording unit 122, the cause tracking device displays the event information of No. 4 and the event information of each of No. 1 and No. 3 related to the event of No. 4 on the monitor of the operating terminal or the like.

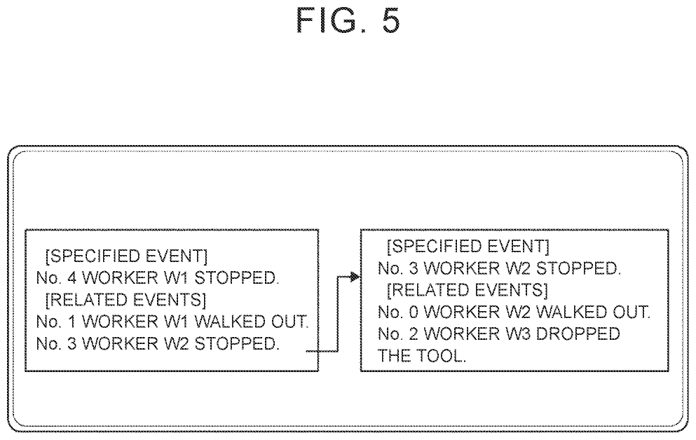

FIG. 5 is a diagram illustrating an example of display contents of a monitor. Referring to FIG. 5, the monitor displays the event information of No. 4 designated as the cause-tracking target and the event information of each of No. 1 and No. 3 related to the event of No. 4. As a result, it can be seen that the reason why the worker W1 stopped is probably due to the fact that the worker W2 stopped immediately before that.

In FIG. 5, event data of each of No. 0 and No. 2 related to the event of No. 3 is also displayed. As a result, it can be seen that the reason why the worker W2 stopped is probably due to the worker W3 dropping the tool immediately before that.

In other words, the user of the present system can determine that the reason why the worker W1 stopped is likely to be caused by the worker W2 stopped so that the worker W3 does not step on the dropped tool immediately before the stop.

### Second Application Case of the Cause Tracking System 1

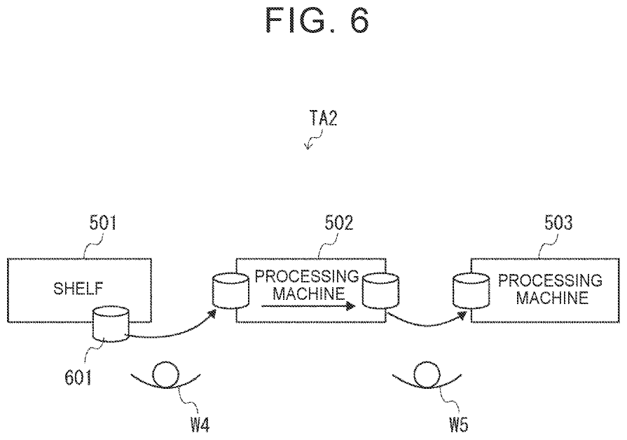

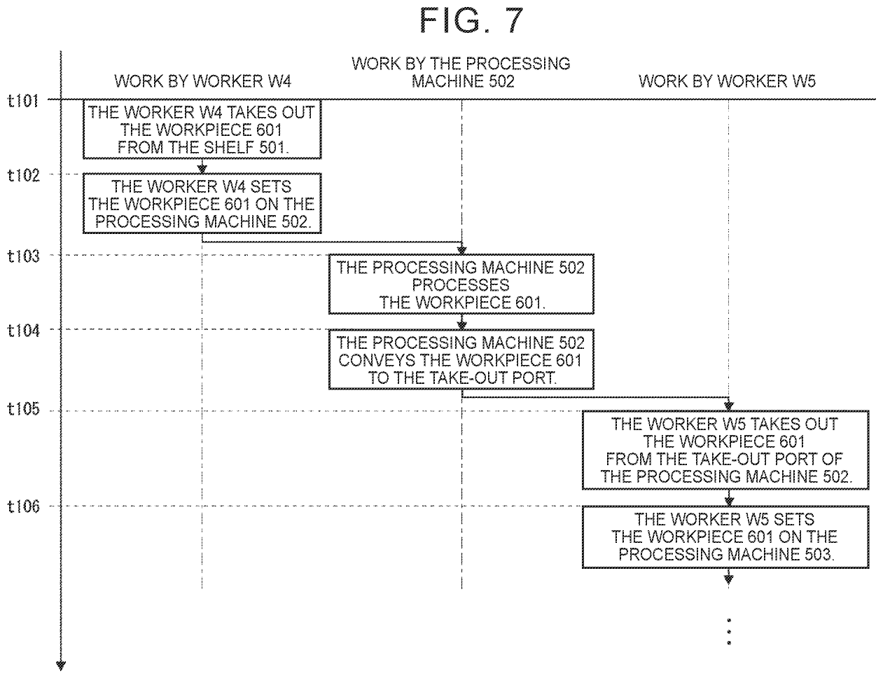

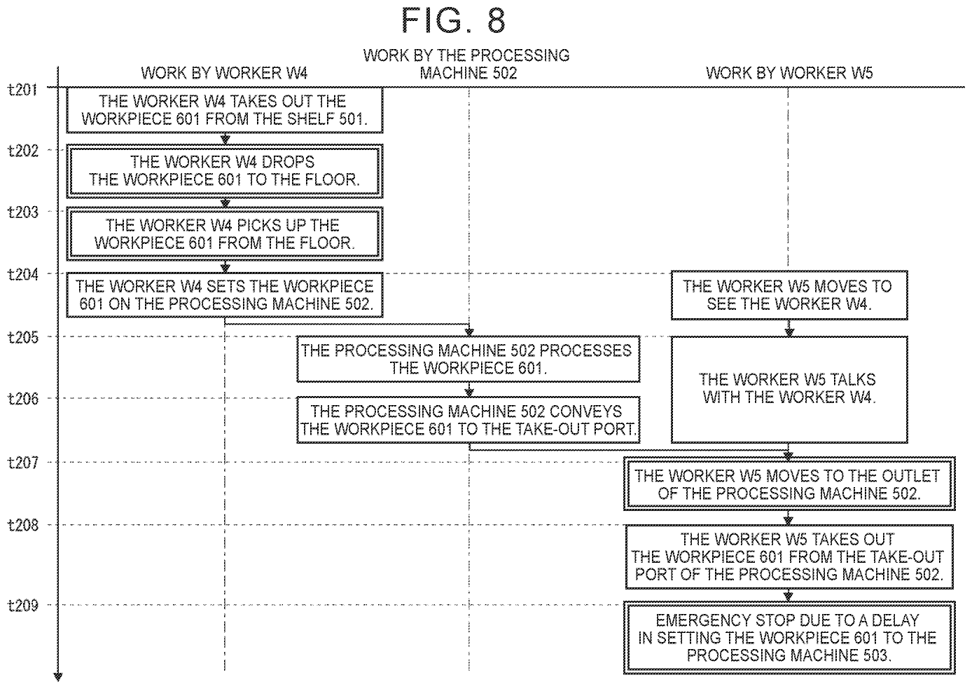

FIG. 6 is a schematic diagram illustrating a second application case of the cause tracking system 1. FIG. 7 is a diagram for explaining a flow of occurrence of an event at a normal time in the second application case of the cause tracking system 1. FIG. 8 is a diagram for explaining a flow of occurrence of an event at the time of abnormality in the second application case of the cause tracking system 1.

In the example of FIG. 6, the cause tracking system 1 is applied to a facility such as a factory, and detects an object such as an operator and a processing machine existing in a management target area TA2. In the example of FIG. 6, two worker W4, W5 exist as the worker 901 in the management target area TA2, and the shelf 501, the processing machine 502, and the processing machine 503 are installed.

First, the flow of normal-time events in the management target area TA2 will be described with reference to FIG. 7. First, the worker W4 takes out the workpiece 601, which is a workpiece, from the shelf 501 (time t101). Thereafter, the worker W4 sets the workpiece 601 in the processing machine 502 (time t102). Thereafter, the processing machine 502 processes the workpiece 601 (time t103). Thereafter, the processing machine 502 transports the workpiece 601 to the take-out port (time t104). Thereafter, the worker W5 takes out the workpiece 601 from the take-out port of the processing machine 502 (time t105). Thereafter, the worker W5 sets the workpiece 601 in the processing machine 503 (time t106). The description of the subsequent processing of the workpiece 601 by the processing machine 503 and the like will be omitted.

Next, the flow of events occurring at the time of an error in the management target area TA2 will be described with reference to FIG. 8. First, the worker W4 takes out the workpiece 601, which is a workpiece, from the shelf 501 (time t201). Thereafter, the worker W4 drops the workpiece 601 to the floor (time t202). Thereafter, the worker W4 picks up the workpiece 601 from the floor (time t203). Thereafter, the worker W4 sets the workpiece 601 in the processing machine 502 (time t204). The delay caused by the worker W4 dropping the workpiece 601 to the floor was within the allowable period. At this time, the worker W5 moves to the vicinity of the worker W4 to see the state of the worker W4 (time t204).

Thereafter, the processing machine 502 processes the workpiece 601 (time t205). Thereafter, the processing machine 502 transports the workpiece 601 to the take-out port (time t206). Here, the worker W5 talks with the worker W4 during processing of the workpiece 601 by the processing machine 502. After the processing of the workpiece 601 by the processing machine 502 is completed, the worker W5 moves to the take-out port of the processing machine 502 (time t207). The delay caused by the worker W5 returning to the holding hall after talking with the worker W4 was within the allowable period.

Thereafter, the worker W5 takes out the workpiece 601 from the take-out port of the processing machine 502 (time t208). Thereafter, prior to the worker W5 setting the workpiece 601 in the processing machine 503, the accumulated delay has exceeded the allowable time, so that the processing machine 503 is stopped urgently (time t209).

In the recording unit 122 provided in the cause tracking device 12, an event generated at each time is recorded in a state associated with a related event. At this time, the cause tracking device 12 reads other past events related to the event “the processing machine 503 has stopped urgently” from the recording unit 122 and outputs the other past events, for example, when tracking the cause of occurrence of the event “the processing machine 503 has stopped urgently”. For example, the cause tracking device 12 outputs, as other past events related to the event “the processing machine 503 has stopped urgently”, past events such as “the worker W4 drops the workpiece 601 to the floor”, “the worker W4 picks up the workpiece 601 from the floor”, and “the worker W5 moves to the take-out port of the processing machine 502”. Thus, the user of the system can determine that there is a high possibility that the machine 503 is urgently stopped because the worker W4 dropped the workpiece 601 to the floor and the worker W5 left the place to view the state of the worker W4 who dropped the workpiece 601 to the floor.

As described above, the cause tracking system 1 according to the present embodiment can preferentially present an event having high relevance to the designated event when tracking the cause of occurrence of the event designated as the cause tracking target by associating the detected new event with a past event having high relevance to the new event and recording the event in the recording unit as a past event. Here, the cause tracking system 1 according to the present embodiment, unlike the case of JP 2014-127093 A, without performing large-scale data collection in advance, from the initial start of operation, it is possible to identify the cause of occurrence of the specified event. That is, the cause tracking system 1 according to the present embodiment can easily identify the cause of occurrence of a designated event without performing large-scale data collection in advance.

Note that, in the cause tracking system 1, the event detecting unit 121 provided in the cause tracking device 12 may be configured to detect the event as a new event of the cause tracking target candidate when the numerical value indicating the degree of normality of the event generated at the predetermined location exceeds the range of the allowable value assigned to the predetermined location.

For example, in a case where an allowable work time of 5 to 20 seconds is set for a predetermined work, in a case where the work time of the predetermined work is 30 seconds that exceeds the allowable work time, the event detecting unit 121 may detect the work performed for more than 30 seconds as a new event of the cause tracking target candidate. Thereby, the user of the present system can easily select an event to be tracked.

In addition, in the cause tracking system 1, the recording control unit 124 provided in the cause tracking device 12 may be configured to delete, from the recording unit 122, a past event whose degree of association with another past event is equal to or less than a predetermined value among a plurality of past events recorded in the recording unit 122. That is, the recording control unit 124 may be configured to delete, from the recording unit 122, a past event that is not related to another past event among a plurality of past events recorded in the recording unit 122. As a result, the amount of data recorded in the recording unit 122 is reduced.

Further, in the cause tracking system 1, the calculation result of the calculating unit 123 may be further accumulated in the recording unit 122 provided in the cause tracking device 12. The cause tracking device 12 may further include a presenting unit that presents an arrangement plan of the sensors 11_1 to 11_n based on the calculation result of the calculating unit 123 accumulated in the recording unit 122. The content presented by the presenting unit is displayed on the monitor together with the content output by the output unit 125, for example. For example, the presenting unit may present that the number of sensor arrangements in an area having a low event occurrence probability is reduced, the number of sensor arrangements in an area having a high event occurrence probability is increased, and the like.

Further, in the cause tracking system 1, the output unit 125 provided in the cause tracking device 12 may be configured to preferentially output from an event that is highly related to the designated event among other past event OE related to the event designated as the cause tracking target. Thus, the output unit 125 can output only other past event OE that are particularly highly related to the event designated as the cause tracking target even when there are many other past event OE related to the event designated as the cause tracking target, for example.

The present disclosure is not limited to the above-described embodiments, and can be appropriately modified without departing from the spirit thereof.

In addition, some or all of the processes of the cause tracking device 12 can be realized by causing a Central Processing Unit (CPU) to execute a computer program.

The programs described above include instructions (or software code) that, when loaded into a computer, cause the computer to perform one or more of the functions described in the embodiments. The program may be stored in a non-transitory computer-readable medium or a tangible storage medium. By way of example, and not limitation, computer-readable media or tangible storage media include Random Access Memory (RAM), Read only memory (ROM), flash memory, Solid State Drive (SSD) or other memory techniques, Compact Disc Read only memory (CD-ROM), Digital Versatile Disc (DVD), Blu-ray disk or other optical disk storage, magnetic cassettes, magnetic tape, magnetic disk storage or other magnetic storage devices. The program may be transmitted on a transitory computer-readable medium or a communication medium. The example of the transitory computer-readable medium or the communication medium includes, but is not limited to, an electrical, optical, acoustic, or other form of propagating signal.

What is claimed is:

1. A cause tracking system comprising:
an event detecting unit that detects a new event that has occurred in a management target area;
a recording unit in which events detected in the past by the event detecting unit are recorded;
a calculating unit that calculates a degree of association between the new event detected by the event detecting unit and past events recorded in the recording unit;
a recording control unit that links the new event with information on a past event in which the degree of association with the new event is equal to or higher than a threshold value among the past events recorded in the recording unit, and causes the recording unit to record the new event as the past event; and
an output unit that reads out a designated event among the past events recorded in the recording unit and other past events associated with the designated event from the recording unit, and outputting the designated event and the other past events.

2. The cause tracking system according to claim 1, wherein the calculating unit is configured to calculate the degree of association between the new event detected by the event detecting unit and the past events recorded in the recording unit based on at least one of an occurrence location and an occurrence time of each of the new event and the past events.

3. The cause tracking system according to claim 1, wherein the calculating unit is configured to calculate the degree of association between the new event detected by the event detecting unit and the past events recorded in the recording unit based on a person involved in occurrence of each of the new event and the past events.

4. The cause tracking system according to claim 1, wherein the event detecting unit is configured to detect an event that has occurred at a predetermined location as the new event serving as a cause tracking target when a numerical value indicating a degree of normality of the event exceeds a range of an allowable value assigned to the predetermined location.

5. The cause tracking system according to claim 1, wherein the recording control unit deletes a past even in which the degree of association with the other past events is equal to or lower than a predetermined value among the past events recorded in the recording unit.

6. The cause tracking system according to claim 1, wherein the event detecting unit is configured to detect the new event using a camera.

7. The cause tracking system according to claim 1, wherein:
a calculation result by the calculating unit is further accumulated in the recording unit; and
the cause tracking system further includes a presenting unit that presents an arrangement plan of a camera based on the calculation result by the calculating unit, the calculation result being accumulated in the recording unit.

8. The cause tracking system according to claim 1, wherein the output unit preferentially outputs an event in which the degree of association with the designated event is high among the other past events associated with the designated event.

9. The cause tracking system according to claim 1, wherein the output unit reads out the designated event among the past events recorded in the recording unit and the other past events associated with the designated event from the recording unit, and displays the designated event and the other past events on a monitor.

10. The cause tracking system according to claim 1, wherein when the past events are not recorded in the recording unit, the recording control unit causes the recording unit to record the new event without linking the new event with information on the past events.

11. A cause tracking method comprising:
detecting a new event that has occurred in a management target area;
calculating a degree of association between the new event and events detected in the past and recorded in a recording unit;
linking the new event with information on a past event in which the degree of association with the new event is equal to or higher than a threshold value among past events recorded in the recording unit, and causing the recording unit to record the new event as the past event; and
reading out a designated event among the past events recorded in the recording unit and other past events associated with the designated event from the recording unit, and outputting the designated event and the other past events.

12. A non-transitory storage medium storing a cause tracking program that causes a computer to execute processes comprising:
detecting a new event that has occurred in a management target area;
calculating a degree of association between the new event and events detected in the past and recorded in a recording unit;
linking the new event with information on a past event in which the degree of association with the new event is equal to or higher than a threshold value among past events recorded in the recording unit, and causing the recording unit to record the new event as the past event; and
reading out a designated event among the past events recorded in the recording unit and other past events associated with the designated event from the recording unit, and outputting the designated event and the other past events.
